(19) United States
(12) Patent Application Publication
(10) Pub. No.: US 2016/0332513 A1
(43) Pub. Date: Nov. 17, 2016

(54) CONTAMINATION BARRIERS FOR CONTAINERS HAVING PORTS

(71) Applicant: Bret Goss, Chehalis, WA (US)

(72) Inventor: Bret Goss, Chehalis, WA (US)

(21) Appl. No.: 15/069,612

(22) Filed: Mar. 14, 2016

Related U.S. Application Data
(60) Provisional application No. 62/161,036, filed on May 13, 2015.

(51) Int. Cl. B60K 15/05; B65D 51/24

(52) U.S. Cl. CPC B60K 15/05; B65D 51/24

(57) ABSTRACT

Contamination barriers that may be removably placed by a user on a cap covering a port of a container to maintain a clean cap and surrounding area to prevent contaminants entering the port when the user desires to remove the cap. The contamination barriers include a sheet member with a recess. The recess includes an opening that leads to an enclosed pocket for the cap. The sheet member also includes a brim, surrounding and extending radially from the opening of the cap recess. A collar is disposed around the opening. In some examples, a retaining member is secured to the sheet member is configured to selectively compress the cap recess around an inserted cap. In some examples, the collar around the opening is resilient. The resilient collar is configured to compress the opening around the cap while still allowing vapors from the container to vent to the atmosphere.

### CROSS REFERENCE TO RELATED APPLICATIONS

This application claims priority to copending U.S. Application, Ser. No. 62/161,036, filed on May 13, 2015, which is hereby incorporated by reference for all purposes.

### BACKGROUND

The present disclosure relates generally to contamination barriers. In particular, contamination barriers to cover caps on ports of containers are described.

Known contamination barriers are not entirely satisfactory for the range of applications in which they are employed. For example, existing contamination barriers are often caps that screw into ports on containers to provide a barrier against contaminants entering the container through the port. For example, in dirty conditions, such as on the fuel port or diesel exhaust fluid port of diesel-powered construction machinery, a cap and the surrounding area can build up dirt or other contaminants that can then enter the port when the cap is removed. Many systems, such as diesel exhaust fluid systems, can be significantly damaged by contaminants entering through the port. Further, conventional contamination barriers are often stand-alone screw-in caps that are prohibitively expensive to replace with new, clean barriers each time the port needs to be opened.

Thus, there exists a need for contamination barriers for ports on containers that improve upon and advance the design of known contamination barriers. Examples of new and useful contamination barriers relevant to the needs existing in the field are discussed below.

### SUMMARY

The present disclosure is directed to contamination barriers configured to be removably placed by a user on a cap covering a port of a container to maintain a clean cap and surrounding area to prevent contaminants entering the port when the user desires to remove the cap. The contamination barriers include a sheet member with a recess to receive a cap.

The recess includes an opening that leads to an enclosed pocket. The recess is configured to receive the cap through the opening and cover the cap in the enclosed pocket. The sheet member also includes a brim, surrounding and extending radially from the opening of the cap recess. A collar is disposed around the opening of the cap recess. Also provided is a retaining member secured to the sheet member and configured to selectively compress the cap recess around an inserted cap.

In some examples, a contamination barrier may use a resilient collar around the opening of the cap recess. The resilient collar is configured to compress the opening around the cap when the cap is inserted into the cap recess. The resilient collar is further configured to compress the opening while still allowing vapors from the container to vent to the atmosphere.

### BRIEF DESCRIPTION OF THE DRAWINGS

FIG. 1 is a top view of a first example of a contamination barrier for a container having a cap covering a port depicting a retaining member in a disengaged position.

FIG. 2 is a bottom view of the contamination barrier shown in FIG. 1.

FIG. 3 is a perspective view of the contamination barrier shown in FIG. 1 depicting a retaining member in a disengaged position.

FIG. 4 is a perspective view of the contamination barrier shown in FIG. 1 depicting a retaining member in an engaged position around the cap recess.

FIG. 5 is a bottom view of the contamination barrier shown in FIG. 1 with the collar stretched radially away from the cap recess.

FIG. 6 is a perspective view of an example of a port with a cap and the contamination barrier above the cap with an arrow showing that the contamination barrier will be positioned over the cap.

FIG. 7 is a perspective view of the contamination barrier shown in FIG. 4 depicting the cap shown in FIG. 6 inserted into the cap recess with a retaining member in an engaged position around the cap recess.

FIG. 8 is a bottom view of the contamination barrier shown in FIG. 1 depicting a wipe attached to the inner face.

### DETAILED DESCRIPTION

The disclosed contamination barriers for ports on containers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various contamination barriers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The present disclosure describes contamination barriers that address the shortcomings of existing contaminations barriers. A contamination barrier may be removably placed by a user on a cap covering a port of a container to maintain a clean cap and surrounding area to prevent contaminants entering the port when the user desires to remove the cap. Further, the contamination barriers described can be made cheaply and disposable so that a user can conveniently replace a used contamination barrier with a new one when the port is opened. This reduces the risk of contaminants entering through the port. One example of an application is for covering diesel fuel caps on off-road construction machinery. Another example of an application is for covering diesel-exhaust fluid (DEF) caps. DEF is sometimes a required part of a diesel engine's emissions system and can be particularly sensitive to damage by contaminants, such as, for example, dirt, entering the DEF container through its port.

A first example of a contamination barrier 100 will now be described. The reader will appreciate from the figures and description below that contamination barrier 100 addresses shortcomings of conventional contamination barriers.

For example, contamination barrier 100 envelopes a port cap on a container and extends outward to shield the cap and surrounding area from contaminants. Contaminants might include, for example, dirt, water, or other substances the user desires to exclude from the container. Contamination barrier 100 can be easily yet securedly placed on a cap and easily removed. Further, contamination barrier 100 may be made of any appropriate material with the characteristics desired by the user, including readily-available materials such as tarpaulin, for example, that make it cost-effective for a user to replace the contamination barrier with a new, clean one as often as needed.

Contamination barrier 100 includes a sheet member 110, a recess 120, a collar 130, and a retaining member 140. In other examples, the contamination barrier includes additional or alternative features, such as wipe member 150.

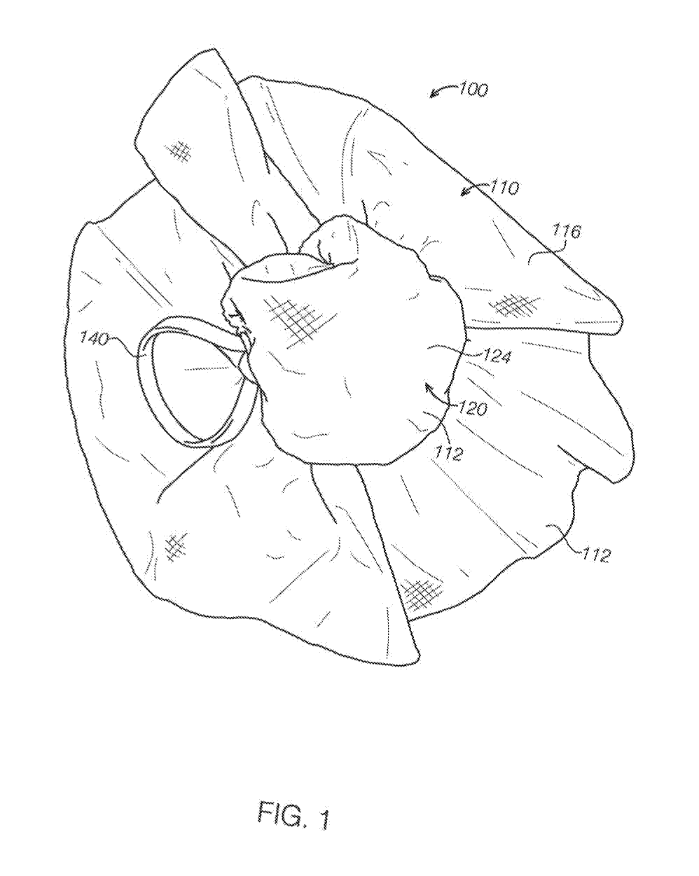

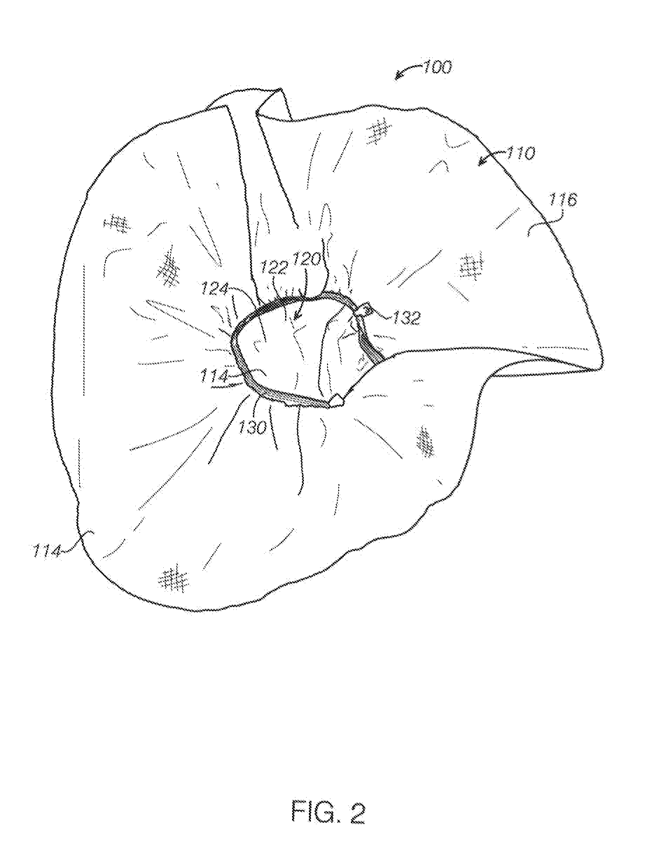

As shown in FIGS. 1 and 2, sheet member 110 defines a recess 120 configured to receive a cap. Sheet member 110 defines an inner face 112 opposite an outer face 114. When cap 118 is inserted into recess 120 of contamination barrier 100, cap 118 is in contact with inner face 112. It should be understood that contamination barrier 100 can be placed on a cap in whatever orientation the user desires, such as, for example, with cap 118 in contact with outer face 114. For example, if the inner face of a new contamination barrier had accumulated dirt before use, the user may reverse the contamination barrier.

In the present example, sheet member 110 is flexible and made of a water-resistant tarpaulin material that is selected to restrict particulate matter from passing through the sheet member 110. It should be understood that the sheet member may be formed from any desired material, such as polyethylene, vinyl, or cotton, depending on the particular needs and desires of the user.

The sheet member may be stiff or flexible with whatever degree of plasticity the user desires to mold recess 120 around the cap and brim 116 around the surrounding area. The sheet member may also be water-resistant or not, configured to allow vapors to pass through or not, and configured to selectively allow particular matter of a chosen size to pass through or not, depending on the particular needs and desires of the user.

It should be understood that the sheet member may be any color, but that a user may desire to use a particular color to coordinate with a particular port, such as, for example, using a green sheet member for a diesel-fuel port cap and a blue sheet member for a diesel-exhaust fluid (DEF) port cap, to ease identifying the appropriate substance for a container.

As can be seen in FIGS. 1 and 2, recess 120 includes opening 122 that leads to an enclosed pocket 124. Collar 130 is disposed around opening 114 of recess 112. In the present example, collar 130 is made into a loop by means of collar connector 132. Collar 130 is situated around opening 114 on inner face 112 with cap 118 in contact with inner face 112.

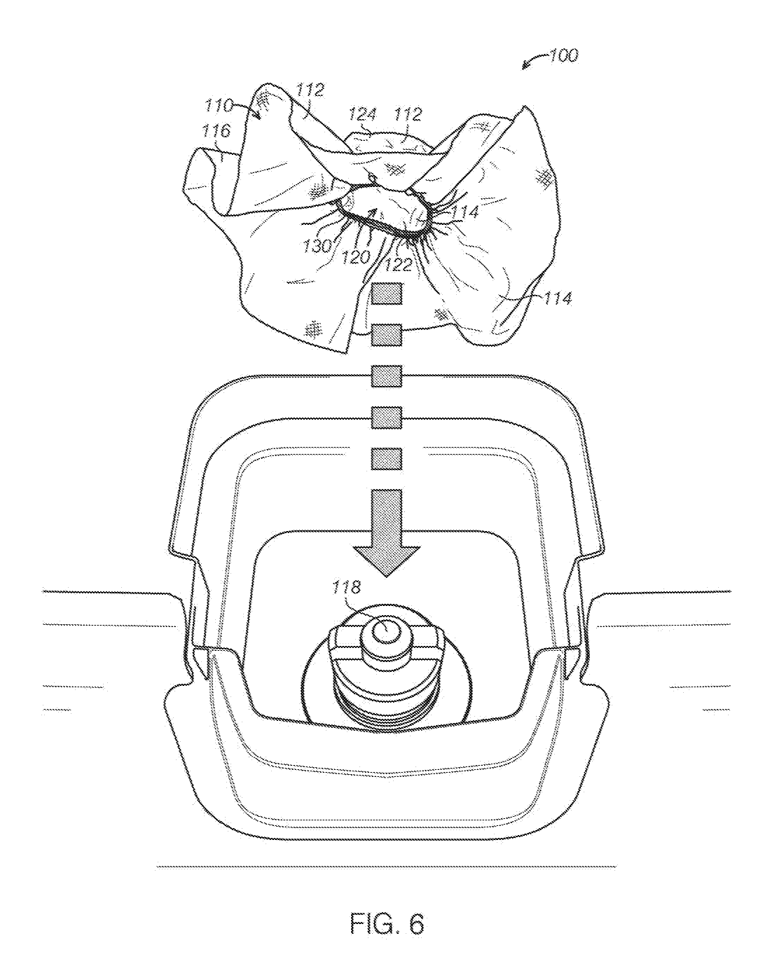

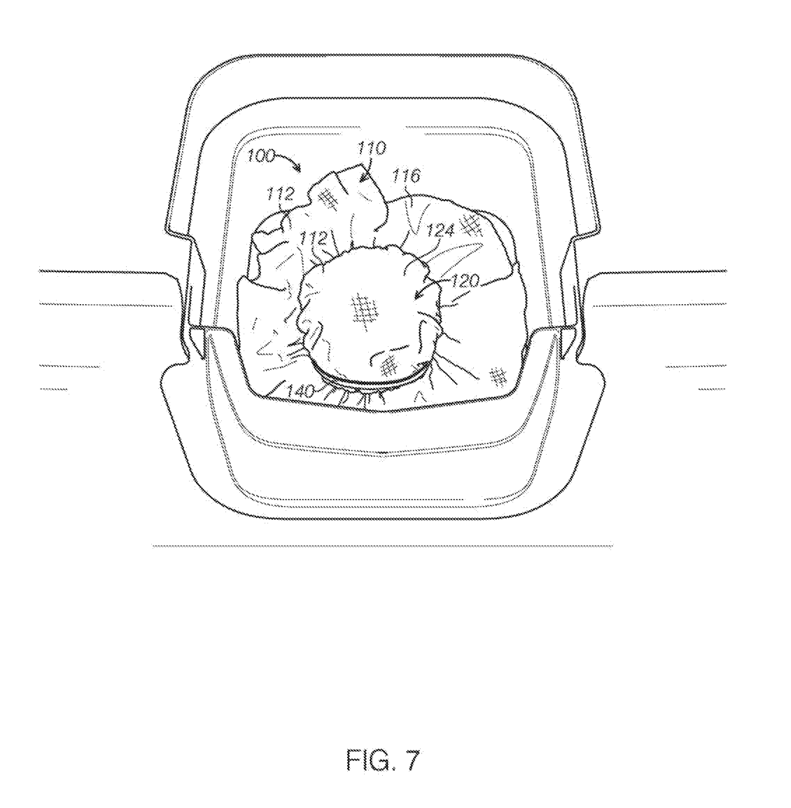

As can be seen in FIGS. 6 and 7, recess 120 is configured to receive port cap 118 through opening 122 and cover cap 118 with enclosed pocket 124.

In the present example, collar 130 is resilient, made of a braided elastic with sufficient resiliency to allow the user to stretch the opening wide enough to fit over cap 118 and, once cap 118 is inserted through opening 122 into enclosed pocket 124, to compress around the base of cap 118 without forming an airtight seal. The compression functions to keep contamination barrier 100 situated on cap 118 with brim 116 extending outward without falling off during use, such as when used to cover a diesel exhaust fluid (“DEF”) cap on a construction machine like a bulldozer.

While the contamination barrier 100 stays on during use, the lack of an airtight seal enables vapors that might escape from the container's port to vent to the atmosphere. This venting avoids fumes, which might be toxic, flammable, or otherwise hazardous, building up under contamination barrier 100 and escaping when the user removes it. It should be understood that collar 130 could be made of any material, such as, for example, a non-resilient cord, depending on the particular needs and desires of the user.

As shown in FIGS. 1 and 2, sheet member 110 also includes brim 116, surrounding and extending radially from opening 122 of recess 120.

As illustrated in FIGS. 6 and 7, brim 116 extends radially from recess 120 to shield the area surrounding the cap from contaminants. In the present example, brim 116 is circular, but it should be understood that the brim can be made or cut into any shape the user desires. Further, brim 116 is made from the same material as enclosed pocket 124, but it should be understood that the brim and enclosed pocket may use different materials according to the user's particular needs and desires. For example, the user may desire a flexible enclosed pocket and a stiff brim, or an enclosed pocket that allows vapors to escape through the material but with an impervious brim.

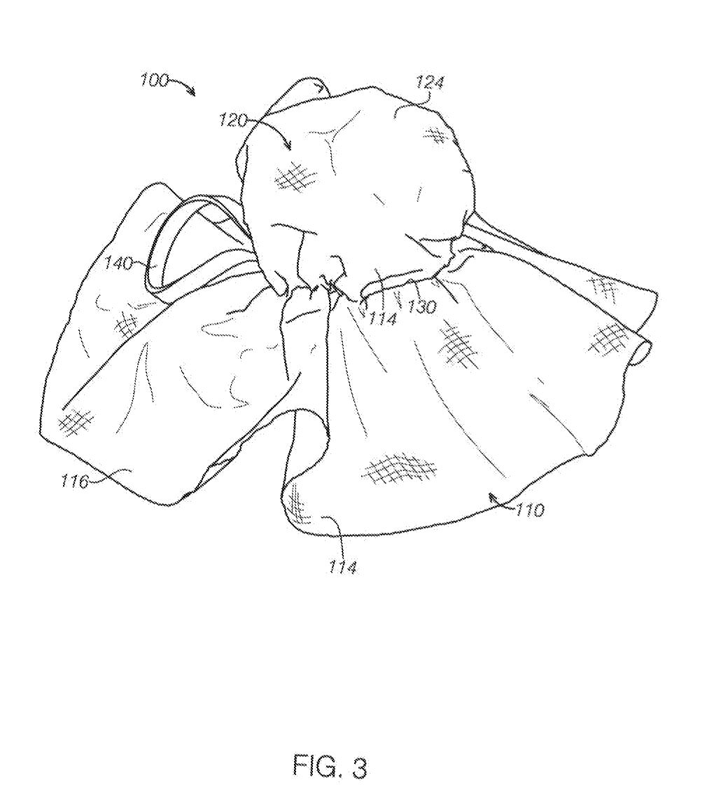

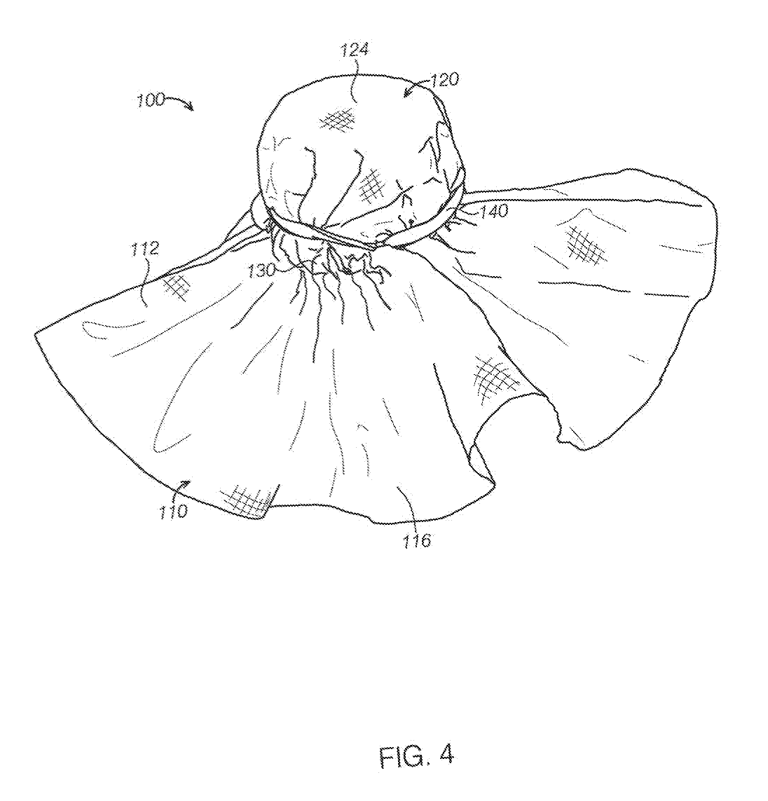

As shown in FIGS. 1, 3, 4, and 7, retaining member 140 is secured to sheet member 110 and configured so the user can selectively compress retaining member 140 around cap 118. In the present example, retaining member 140 is elongate and tension bearing. Retaining member 140 is resilient. In the present example, retaining member 140 is a rubber band configured as a loop and secured to outer face 112 of sheet member 110.

Retaining member 140 functions to help securedly and removably hold contamination barrier 118 over cap 118. Retaining member 140 also functions to hold contamination barrier 100 on cap 118 when collar 130 is not resilient or otherwise lacks sufficient compressive force to hold contamination barrier 100 securedly. It should be understood that the retaining member can be made from any material the user desires, such as, for example, straight, non-resilient cords that the user ties around recess 120 when cap 118 is inserted. Any material can be used for the retaining member depending on the particular needs and desires of the user.

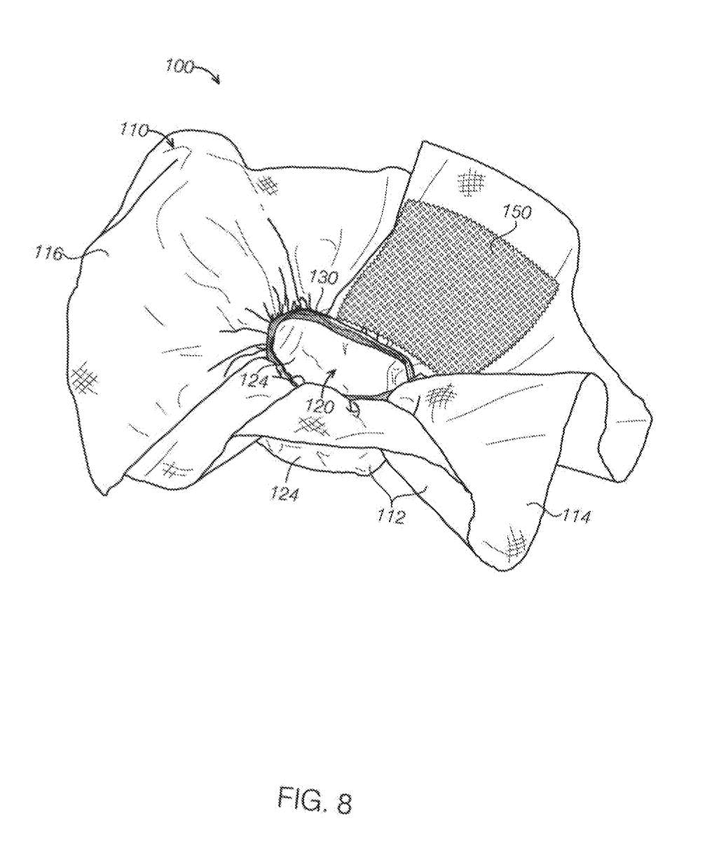

FIG. 8 illustrates wipe member 150 secured to inner face 114 of brim 116. Wipe member 150 is a static-free cloth, which reduces the risk of a spark that might, for example, cause combustion of any flammable vapors that escaped through the port of the container. It should be understood that wipe 150 can be of any material the user desires, such as, for example, cotton or microfiber, depending on the user's particular needs and desires. Wipe 150 allows the user to wipe off any materials accumulated on the cap during use, such as dirt, before opening the cap. In this way the user can further reduce the chance of a contaminant entering the container when the cap is removed.

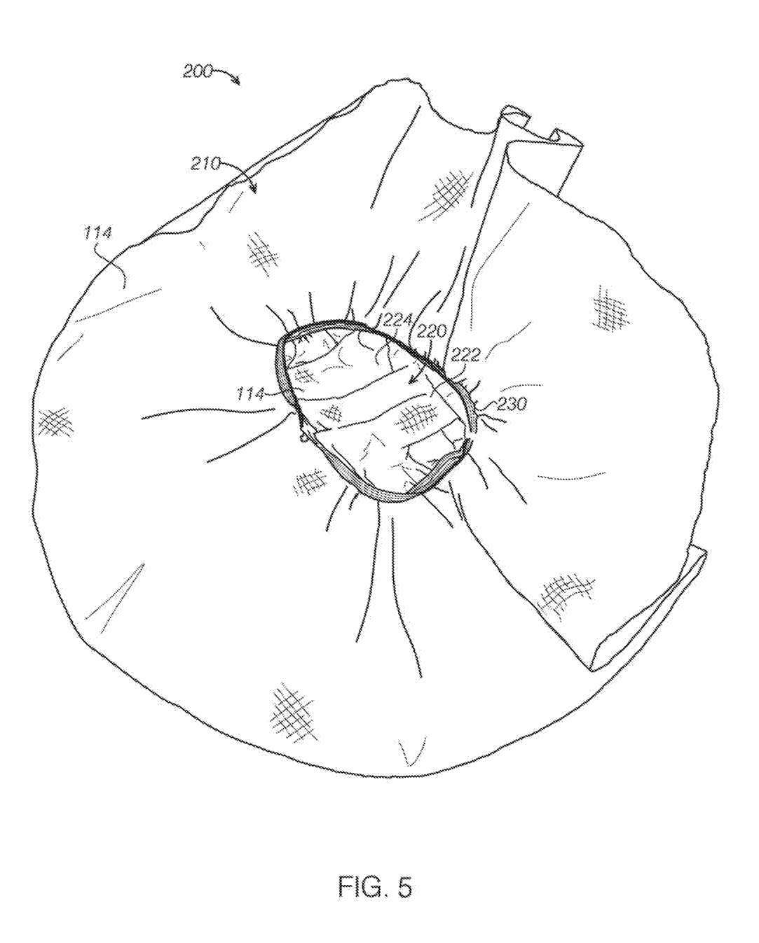

Turning attention to FIG. 5, a second example of a contamination barrier, contamination barrier 200, will now be described. Contamination barrier 200 includes many similar or identical features to contamination barrier 100. Thus, for the sake of brevity, each feature of contamination barrier 200 will not be redundantly explained. Rather, key distinctions between contamination barrier 200 and contamination barrier 100 will be described in detail and the reader should reference the discussion above for features substantially similar between the two contamination barriers.

As can be seen in FIG. 5, contamination barrier 200 includes sheet member 210, recess 220, and collar 230. Unlike contamination barrier 100 in which the collar might not be resilient, contamination barrier 200 uses a resilient collar that compresses around an inserted cap to a compression level chosen to securedly and removably hold the barrier while allowing any vapors that escape through the port to vent to the atmosphere. While a retaining member can be secured to contamination barrier 200, contamination barrier 200 as shown in FIG. 5 does not have a retaining member.

Contamination barrier 200 can include a retaining member that is similar to or the same as retaining member 140. However, it should be understood that the retaining member optionally included with contamination barrier 200 can be formed from any desired material that allows the user to selectively compress recess 220 around an inserted cap and enclose the cap within enclosed pocket 224. For example, cords that the user ties around the cap could be used for the retaining member.

While contamination barrier 100 describes a sheet member that might be flexible or stiff, sheet member 210 is flexible. Sheet member 210 is flexible, but it should be understood that the sheet member may have any degree of resilience or malleability the user desires, depending on the material the user chooses. In the present example, sheet member 210 is made of a tarpaulin material, but any suitable flexible material can be used such as, for example, polyethylene, vinyl, or cotton, depending on the user's particular needs and desires.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A contamination barrier for a container having a cap covering a port, the contamination barrier comprising:
a sheet member configured to define:
a cap recess including an opening on an opening end of the cap recess and an enclosed pocket extending from the opening end, the cap recess being complimentarily configured with the cap to receive the cap through the opening and to cover the cap in the enclosed pocket,
a brim surrounding and extending radially from the opening of the cap recess;
a collar disposed around the opening of the cap recess; and
a retaining member secured to the sheet member and configured to selectively compress the cap recess around the cap when the cap is inserted into the cap recess.

2. The contamination barrier of claim 1, wherein the collar is resilient and configured to selectively expand to increase the size of the opening to receive the cap through the opening and to resiliently compress the opening end of the cap recess to the cap when the cap is inserted into the cap recess.

3. The contamination barrier of claim 2, wherein the resiliency of the collar is selected to compress the opening end of the cap recess to the cap without forming an airtight seal to allow vapors from the fuel container to vent to the atmosphere.

4. The contamination barrier of claim 2, wherein the collar is braided elastic.

5. The contamination barrier of claim 1, wherein the retaining member is an elongate, tension-bearing member.

6. The contamination barrier of claim 5, wherein the retaining member is resilient.

7. The contamination barrier of claim 6, wherein the retaining member is a rubber band.

8. The contamination barrier of claim 1, wherein the sheet member defines an outer face and an inner face opposite the outer face, the cap being in contact with the inner face when inserted into the cap recess.

9. The contamination barrier of claim 8, wherein the retaining member is secured to the sheet member on the outer face.

10. The contamination barrier of claim 8, wherein the collar is disposed around the opening of the cap recess on the inner face.

11. The contamination barrier of claim 8, further comprising a wipe member secured to the inner face.

12. The contamination barrier of claim 11, wherein the wipe member is a static free cloth.

13. The contamination barrier of claim 1, wherein the sheet member includes a water resistant material.

14. The contamination barrier of claim 1, wherein the sheet member includes a material selected to restrict particulates from passing through the sheet member.

15. The contamination barrier of claim 1, wherein the sheet member includes a tarpaulin material.

16. The contamination barrier of claim 1, wherein the sheet member is flexible.

17. A contamination barrier for a container having a cap covering a port, the contamination barrier comprising:
a flexible sheet member configured to define:
a cap recess including an opening on an opening end of the cap recess and an enclosed pocket extending from the opening end, the cap recess being complimentarily configured with the cap to receive the cap through the opening and to cover the cap in the enclosed pocket,
a brim surrounding and extending radially from the opening of the cap recess; and
a resilient collar disposed around the opening of the cap recess and configured to compress the opening end of the cap recess to the cap when the cap is inserted into the cap recess to a compression level selected to allow vapors from the container to vent to the atmosphere.

18. The contamination barrier of claim 17, further comprising a retaining member secured to the flexible sheet member and configured to selectively compress the cap recess around the cap when the cap is inserted into the cap recess

19. The contamination barrier of claim 18, wherein the retaining member is resilient.

20. The contamination barrier of claim 17, wherein the flexible sheet member includes a tarpaulin material.
